(19) United States
(12) Patent Application Publication
(10) Pub. No.: US 2002/0136591 A1
(43) Pub. Date: Sep. 26, 2002

(54) Furniture construction

(76) Inventor: William B. Callahan, San Rafael, CA (US)

Correspondence Address: Richard E. Backus, Law Offices of Richard E. Backus, Suite 490, 685 Market Street, San Francisco, CA, 94105, US

(21) Appl. No.: 10/116,988

(22) Filed: Jun. 5, 2002

Related U.S. Application Data
(63) Continuation-in-part of application No. 09/743,976, filed on Jan. 17, 2001, now abandoned.
Application No. 09/743,976 is a 371 of international application No. PCT/US99/16072, filed on Jul. 16, 1999.
(60) Provisional application No. 60/093,252, filed on Jul. 17, 1998.

(51) Int. Cl. F16B 7/08; F16L 41/00

(52) U.S. Cl. 403/188

(57) ABSTRACT

An assembly for joining pieces of furniture together into a finished furniture unit. Each assembly has a pair of plates, each of which is formed with face and butt elements. Openings are formed through each face for receiving fasteners which join the plates to horizontal rails or other furniture pieces. Other openings are formed through each butt for receiving fasteners which join the butt to vertical pieces such as furniture legs. The openings in the butts are positioned in spaced-apart relationship so that the fasteners are enabled to extend through the leg piece without interference.

This application is a continuation-in-part of application Ser. No. 09/743,976 filed Jan. 1, 2001 which is a Sec. 371 of PCT/US99/16072 filed Jul. 16, 1999 and claims the benefit under 35 U.S.C. Sec. 119(e) of provisional application serial No. 60/093,252 filed Jul. 17, 1998.

### BACKGROUND OF THE INVENTION

1. Field of the Invention

This invention relates to the construction of decorative and durable furniture.

2. Description of the Related Art

In building furniture there are several types of joints. There are primary structural joints that form the overall structure of furniture and there are secondary joints used in various component parts and generally provide substructure support to other furniture components, such as doors, shelving, and drawers. The furniture assembly of this invention is about designing and building primary structural furniture joints.

How joints are formed depends on the joint design and the joining materials. Some joints are constructed wholly from primary component parts (legs and rails) with no secondary joining materials (a hardware fastener for example). This type is known as mortise and tenon joint. The tenon, a projection is cut on the end of a piece of wood (rail) and shaped for insertion into a hole (mortise) cut into the leg to form the joint. Secondary joining materials are most often individual wooden pins, pegs, screws, staples or nails. Sometimes it's a combination of these materials plus an interior bracket such as an internal table leg bracket. In the case of most bed frames, metal bed fasteners (one male, one female) are used to construct the joint. The rail holds the male part and the bed post holds the female part. These types of fasteners are for the most part structural and provide no decorative element. The problem with most furniture with traditional joints like those mentioned above is that when they fail the furniture is no longer useful. Joint failure can be caused over time by extreme stress in and around a joint, seasonal and climatic conditions, and deterioration of the wood surrounding metal screws, often leaving metal fastening hardware loose, unstable, Although such furniture may still have natural and delightful qualities, it has will have lost its usefulness.

### OBJECTS AND SUMMARY OF THE INVENTION

The type of joint of this invention is a structural joint. A plurality of the structural joints are used to connect legs or posts of furniture to cross-members (also known as rails, aprons or skirts), to form a primary furniture structure. The furniture structure can be combined with other component parts, such as a table top, bed slats, or a chair seat to create furniture assemblies.

Integrity of the structural joints is more reliable and more enduring because the assembly hardware is not secured by simply embedding itself into the wood, as with conventional furniture joints. Typically in conventional furniture joints metal screws are used to fasten the parts, sometimes directly into the end grain of a rail which generally is considered one of the weakest places to put a nail, screw or pin.

### BRIEF DESCRIPTION OF THE DRAWINGS

FIG. 1 is a front elevation view of one preferred embodiment of the invention.

FIG. 2 is a side elevation view taken along the line 2-2 of FIG. 1.

FIG. 3 is a front elevation view of a headboard which comprises a component of another embodiment.

FIG. 4 is a front elevation view of a footboard which forms another component of the embodiment of FIG. 3.

FIG. 5 is a plan view of a flat plate shown prior to being formed into a U-plate which is a component of the embodiment of FIG. 1.

FIG. 6 is a perspective view of a U-plate that is formed from the plate of FIG. 5.

FIG. 7 is perspective view showing one step in the mounting of the U-plate of FIG. 6 onto one furniture piece.

FIG. 8 is a perspective view of the U-plate of FIG. 6 showing another step in mounting it with two furniture pieces.

FIG. 9 is a perspective view showing two U-plates oriented along orthogonal axes.

FIG. 10 is perspective view showing the plates of FIG. 9 in assembled relationship with three furniture pieces.

FIG. 11 is a side elevational view of the backplate which forms a component of a U-plate of another embodiment.

FIG. 12 is an end elevation view showing the butt taken along the line 12-12 of FIG. 11.

FIG. 13 is a cross sectional view taken along the line 13-13 of FIG. 12.

FIG. 14 is a side elevational view of the faceplate which forms another m component and taken along the line 14-14 of FIG. 13.

FIG. 15 is a side elevational view of an L-plate in accordance with another embodiment.

FIG. 16 is an end view taken along the line 16-16 of FIG. 15.

FIG. 17 is a fragmentary top view showing assembly of the L-plate of FIG. 15.

FIG. 18 is a top plan view of a V-plate in accordance with another embodiment.

FIG. 19 is a cross sectional view taken along the line 19-19 of FIG. 18.

FIG. 20 is a top plan view of an M-plate in accordance with another embodiment.

FIG. 21 is a cross sectional view taken along the line 21-21 of FIG. 20.

FIG. 22 is a top plan view showing assembly of the V-plate of FIG. 18 and the M-plate of FIG. 20 with a pair of furniture pieces.

FIG. 23 is a top plan view of backplate which forms a component of another embodiment.

FIG. 24 is a cross sectional view taken along the line 24-24 of FIG. 23.

FIG. 25 is a top plan view showing assembly of the backplate of FIG. 23 and the M-plate of FIG. 20 with a pair of furniture pieces.

FIG. 26 is a side elevational view of an J-plate in accordance with another embodiment.

FIG. 27 is an end elevation view taken along the line 27-27 of FIG. 26.

FIG. 28 is a cross sectional view taken along the line 28-28 of FIG. 27.

FIG. 29 is a top plan view of a universal backplate in accordance with another embodiment.

FIG. 30 is a side elevational view taken along the line 30-30 of FIG. 29.

FIG. 31 is a side elevational view taken along the line 31-31 of FIG. 30.

FIG. 32 is a perspective view of an end table comprising corner joints in accordance with another embodiment.

FIG. 33 is a plan view to an enlarged scale showing a three sided plate, prior to being folded, used in the corner joints of FIG. 32.

FIGS. 34a to 34c are perspective views of the three sided plate of FIG. 33 in folded shape showing the steps in turning the plate into different orientations for use on opposite sides of the table leg.

FIG. 35 is a perspective view showing two of the plates of FIGS. 34a to 34c in assembled relationship with the leg and horizontal rails of the table.

### DESCRIPTION OF THE PREFERRED EMBODIMENTS

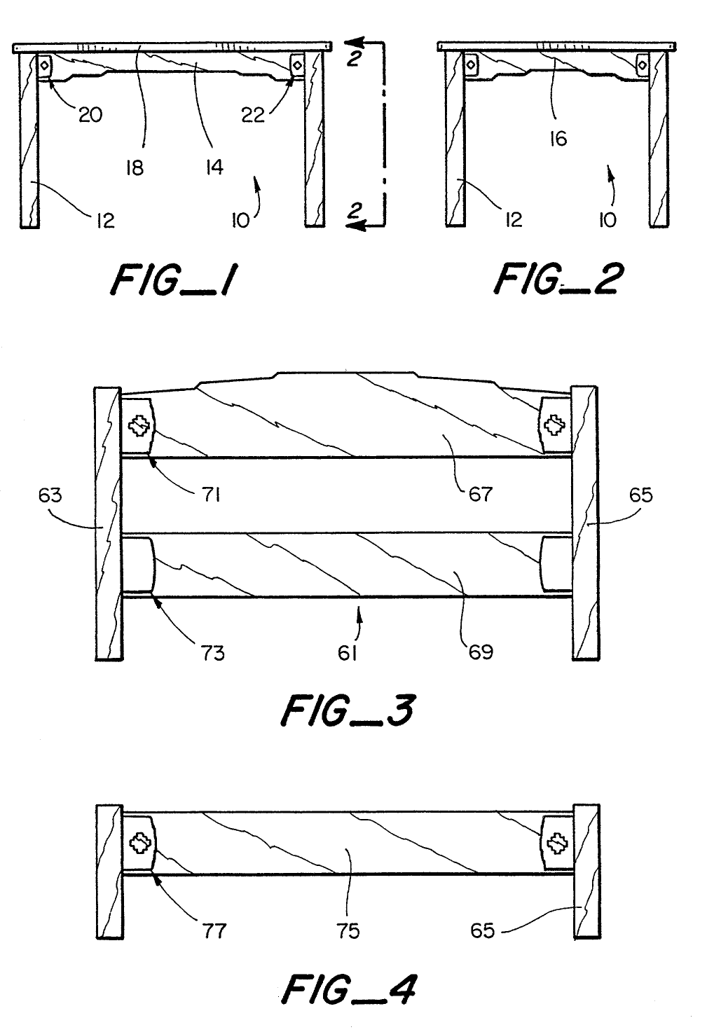

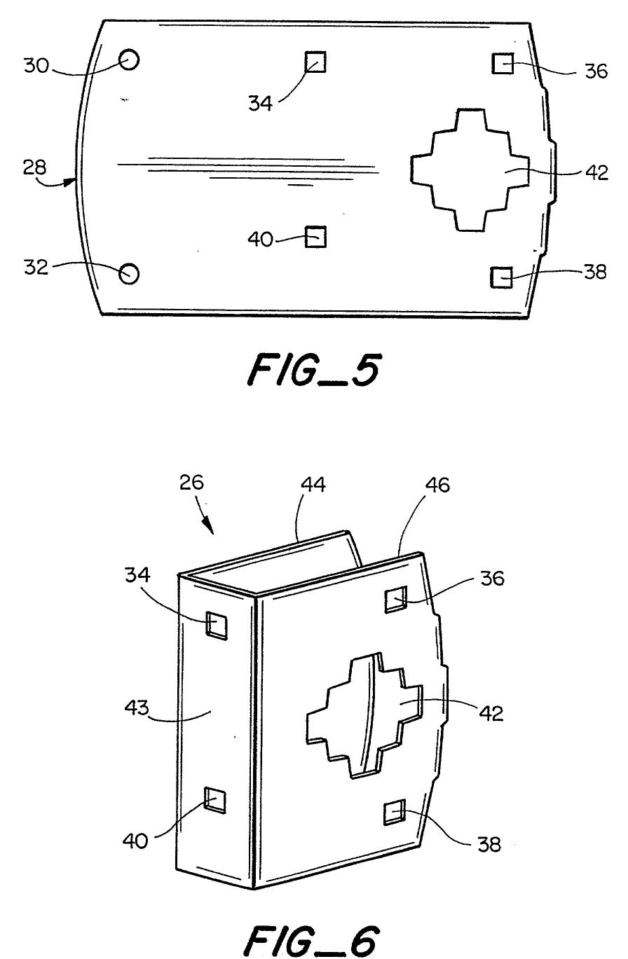

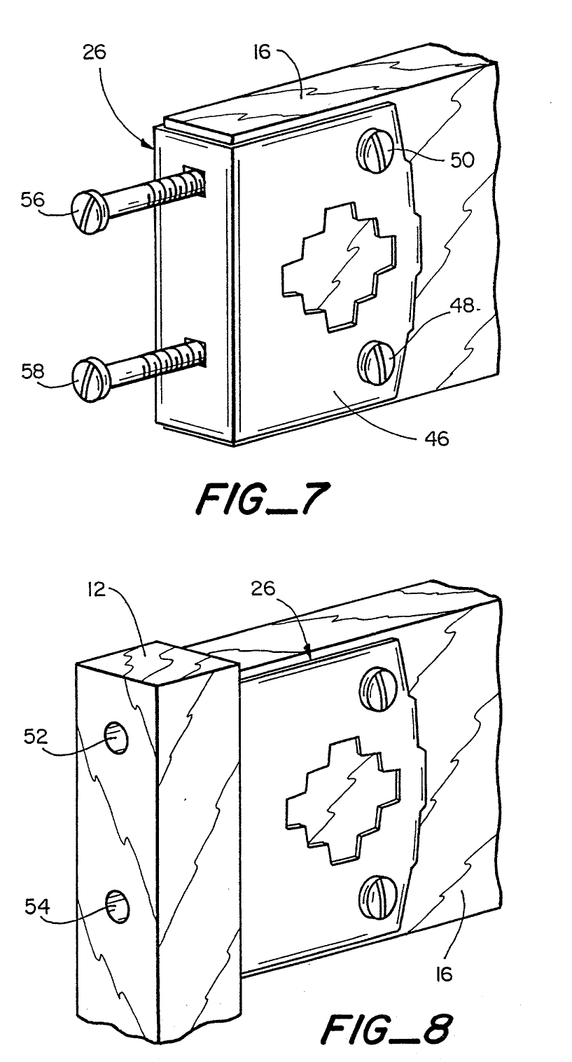

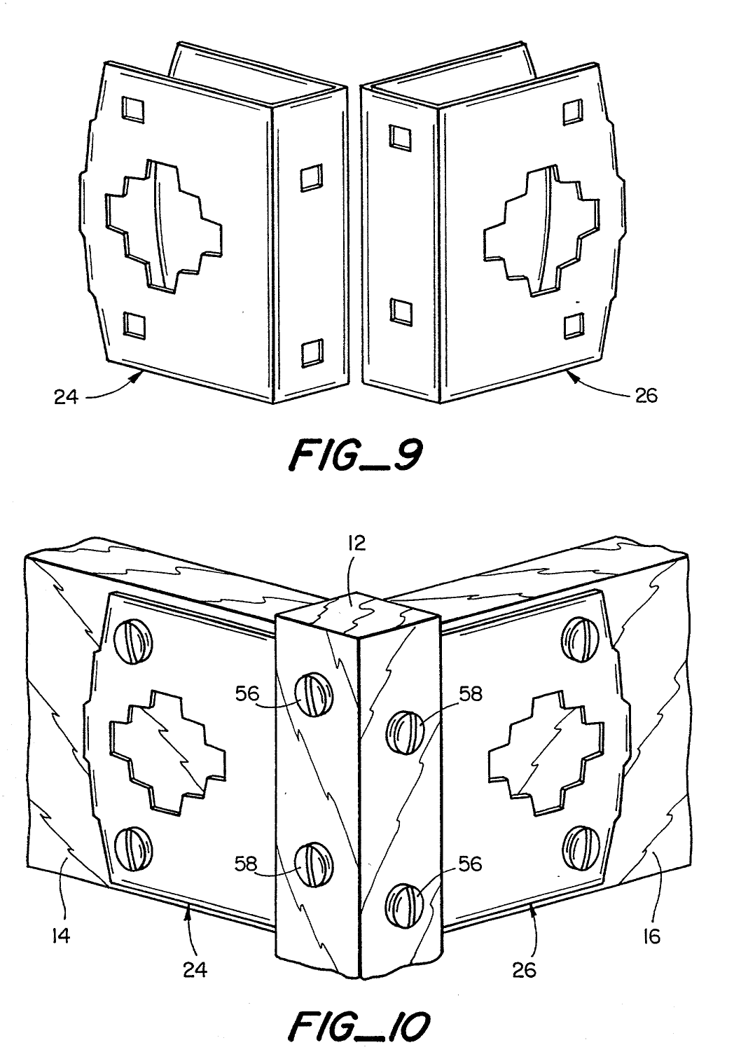

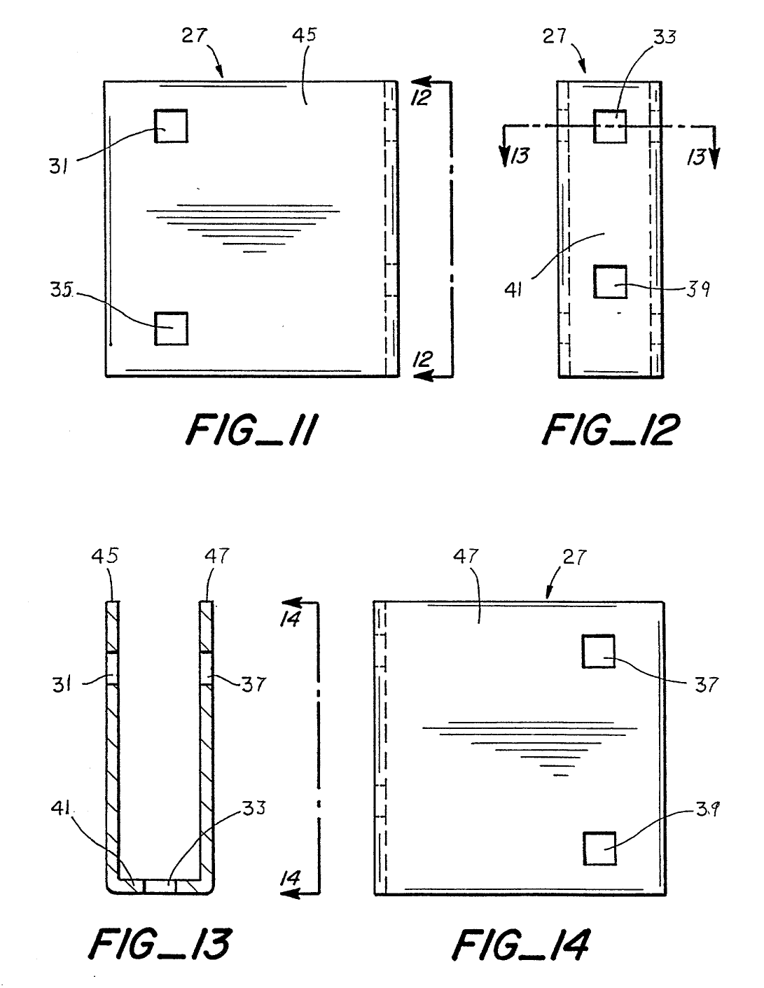

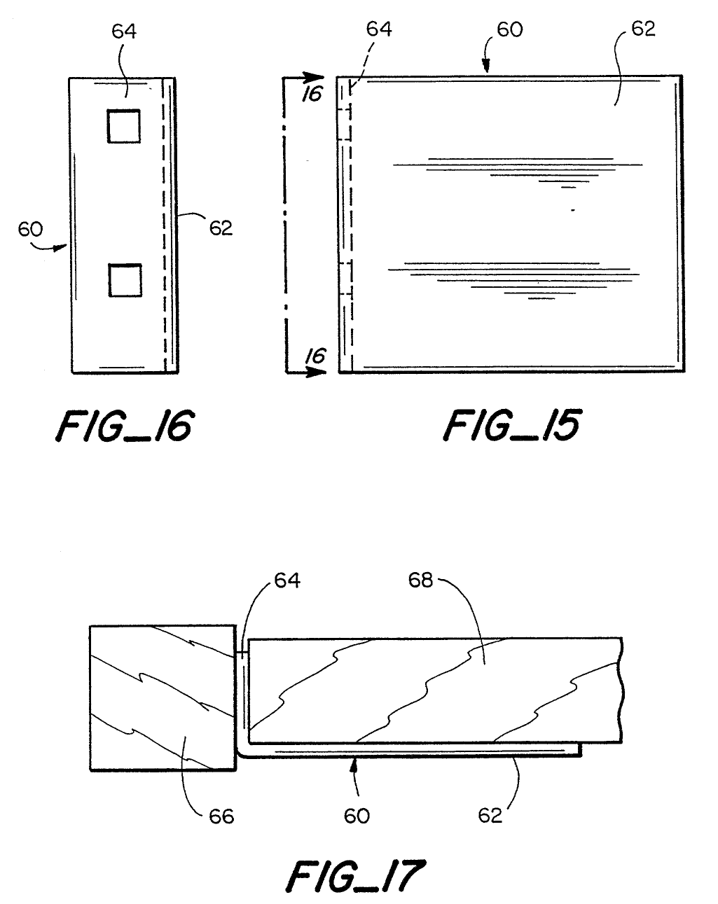

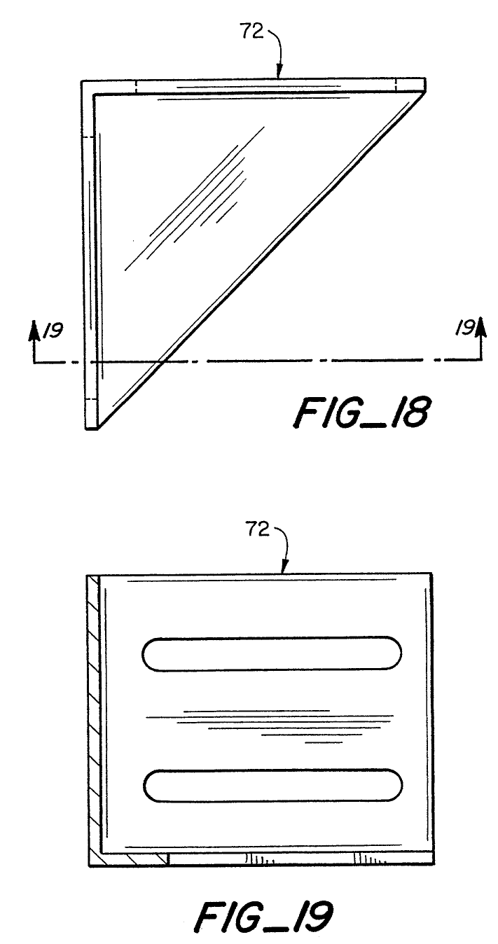

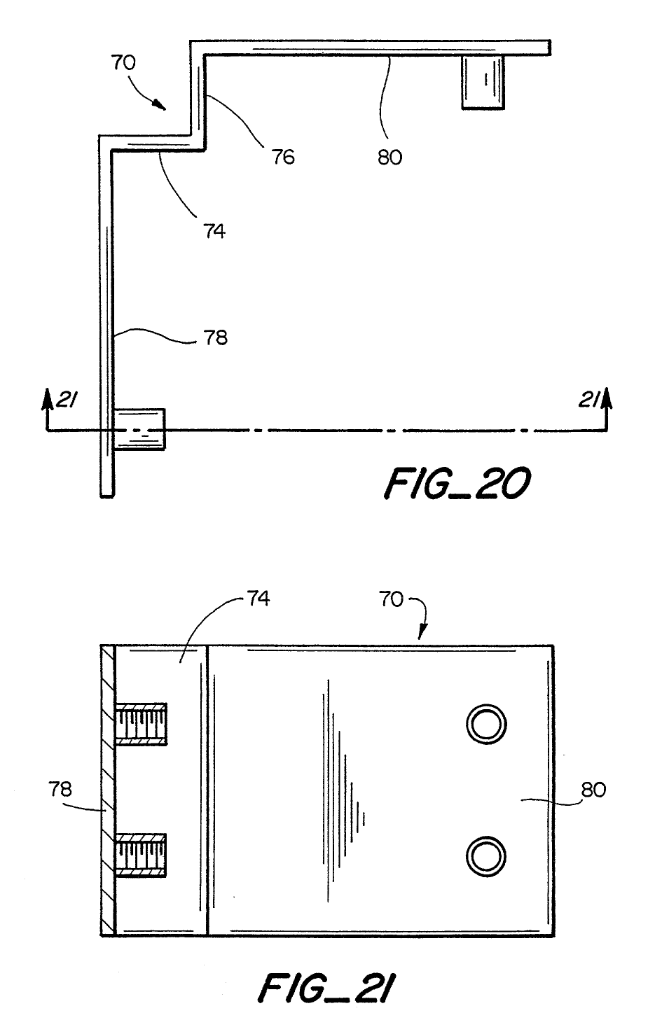

In the drawings FIGS. 1 and 2 illustrate generally at 10 table furniture which comprised of vertical legs 12, horizontal rails 14, 16 and a tabletop 18. The legs and rails are joined together at their intersecting corners by a plurality of furniture assemblies 20, 22. Each corner assembly 20, 22 is comprised of a pair of U-plates 24, 26 which are shown in assembled relationship with the ends of intersecting rails 14, 16 and leg 12. FIG. 9 illustrates the plates 24 and 26 in the orthogonal relationship when they would be assembled.

FIG. 5 illustrates a plate 28 which is flat and formed suitable for embedding into a typical U-plate 26. Plate 28 is formed with a pair of circular holes 30, 32 for receiving the threaded end of a fastener, preferably a barrel nut. Four holes 34, 36, 38 and 40 which are square shaped for fitting with the square cross sectional shoulder of the carriage bolt. An opening 42 is formed through one end of plate 28, with the sides of this opening being suitably shaped for purpose of decorative appeal. As shown in FIG. 5, the distance of hole 34 from the top edge of plate 28 is less than the corresponding distance of hole 40 from the lower edge. This is to enable fasteners which extend through these holes to extend into the furniture pieces without interference from the fasteners which mount the second U-plate, as shown in FIG. 9.

FIG. 6 shows the form of U-plate 26 after it is bent from the flat plate 28. Plate 26 comprises a butt 43 through which the holes 34 and 40 are formed, and a pair of faces 44, 46. Face 46 has the holes 36 and 38 as well as the decorative opening 42. Face 44 has the holes 30, 32.

FIG. 7 shows the U-plate 26 in a step of being assembled with its faces fitted in juxtaposed relationship with opposite sides of rail 16. Carriage bolt 48 is fitted through opposing holes 32, 38 of the two faces, while carriage bolt 50 is fitted through opposing holes 30 and 36.

In the next step of assembly, FIG. 8 the leg 12, which is pre-formed with a pair of holes 52, 54, is aligned to protruding carriage bolts 56, 58 and mounted to butt 42 of assembly and rail 16. The other U-plate 24 is then assembled in a similar manner as shown in FIG. 10. Further assembly is accomplished by inserting pairs of barrel nuts 53, 55 of FIG. 8, through the holes 52, 54 of the leg, which come into threaded engagement with carriage bolts 56, 58. As shown in FIG. 9, the plate 24 is mounted in inverted position relative to that of plate 26. This enables the fasteners which are fitted through the holes 34, 40 of each plate to extend into the third piece, which is the leg, without interference. This results from the offset relationship of the holes 34, 40, as explained in relation to FIG. 5. FIG. 10 shows the assembled fasteners where they extend through the leg 20 without interference.

With the present invention the wooden rail 14 is partially clad externally on a minimum of two surfaces (the butt, and one of the two broad sides), with the assembly plate 20 and having one or more sets of bolts, 56, 58 running through one or more sides of the assembly plate and the wood it secures. The nuts, bolts, studs and sleeves parts used are either male or (interconnecting), and having either an internal or external thread. The fastener(s) are then engaged by screwing them together and through a furniture assembly of this invention, which firmly secures and joins it to the rail. A final step of assembly is accomplished by tightening of all fasteners with the aid of one simple tool.

A furniture assembly of this invention produces a binding so strong and so enduring it will survive the most destructive seasonal and climatic conditions including severe flood conditions. Although a severe flood could cause some wood mold or discoloration from dirt embedded in the grain of the wood, a mild cleaning solution can make the furniture as good as new. If there would be any shrinkage after drying, a simple tightening of the assembly bolts will make it solid again. Even a piece of Arts & Culture furniture completely destroyed by fire, the Furniture assemblies could be salvaged and with some new or recycled wood and a wire brush one could put things happily back together again—and possibly add some new character to the furniture.

There are no standards for the size of a furniture assembly, nor are there any standards for placement of holes or studs in the face, back or side of any furniture assembly design. Also, there is no standard nut and bolt size (width or length), although a ¼-20 inch and 5/16-18 inch threaded diameters appear to be the proper scale for most furniture. When addressing furniture legs, this can also refer or mean furniture “posts,” for example “bed post.” This offsetting distance from the top hole from the top of the butt in comparison to the distance of the bottom hole to the bottom of the plate, allows two Furniture assemblies to intersect at a corner and not have their joining bolts in conflict with one another. This also allows for the two corner plates to be positioned at the same height as one another.

Depending on the furniture theme and supporting furniture assembly design, the face of a furniture assembly may or may not have any exposed fasteners on any of its surfaces. Where no fastener head is visible, this is called a blind/anchored connection, and where the head of a barrel nut or carriage bolt is visible, this is called a through-hole connection because the nut or bolt can be passed through the hole.

A blind/anchored connection is accomplished by having either a stud or sleeve permanently secured to a faceplate/bs (faceplate backside) by way of a weld. A barrel nut is used in conjunction with a stud, and a button head screw is used in conjunction with a sleeve. Tightening of the nut or bolt is accomplished with the aid of one simple tool.

Through-Hole Connections

Exposed connecting bolts used on the faceplates of Furniture assemblies are shaped or sculpted to fit the design theme of the furniture and design of the furniture assembly. Two examples of this might be a square headed bolt with beveled or tapered sides, giving the appearance of a projected tenon, or a bolt head in the shape of a five pointed star. In most cases where an exposed bolt head is used, the hole in which the bolt is placed will be square to accept the square neck of a carriage bolt. Like the blind/anchored connections above, the exposed through-hole connection requires the same simple tool for easy assembly or disassembly. The barrel nut can be tightened from the backplate side of the furniture assembly without the need for a tool to hold the faceplate bolt (possibly a decorative bolt) in place as the barrel nut is turned and tightened from the back.

There are three primary connection methods for connecting furniture assemblies of this invention to the posts or legs of furniture. A first connection method is by means of an exposed barrel nut that screws from the exterior of a leg to the end of a male bolt having a square neck that fits through both the square hole on the butt of a furniture assembly and the leg.

A second connection method is by means of a blind connection (no exposed barrel nut appearing on the furniture leg) where a hanger bolt is screwed into the wood with its pointed threaded. A barrel nut is screwed and tightened from the inside the of the furniture assembly, before the rail is installed. In this situation the holes on the butt of the furniture assemblies are round, rather than square. Where a blind connection of a furniture assembly and a leg is called for (using a hanger type bolt) the holes on the butt will be round. In most cases the furniture assembly will be butted directly against the furniture leg. In some cases where a design calls for it, a mortise will be cut into the leg and the furniture assembly will be inserted into the mortise and then secured. This method, although more labor intensive produces a more finely crafted joint.

An third connection method, which is similar to the previously described exposed through-hole connection method, has a male bolt with sculpted head and a barrel nut which secure the furniture assembly to the furniture leg.

There are three general methods for assembly of a U-plate design and its connection to the legs of a furniture piece:

Assembly method #1—with no connecting fastenings showing on the exterior of furniture legs. The method comprises:

Step 1 the furniture legs 12 are pre-drilled with a single drill bit having two different diameters to receive both the hanger bolt and a barrel nut (the smaller diameter is for receiving the pointed screw end of the hanger bolt and is drilled first and followed by the larger diameter that receives the barrel nut);

Step 2 hanger bolts are screwed into the furniture leg. When complete, the hanger bolt will protrude no more than ⅛ of an inch beyond the joining outsides surface of the leg. Based upon thickness of plate, in this example plate thickness is 0.125 inches;

Step 3. a U-plate 26 is secured to the furniture leg by placing its butt side (round holes) over and onto the projecting hanger bolts, and fully securing it with two barrel nuts;

Step 4. one end of a connecting rail 16 is slid into the opening of the U-plate and fastened with two carriage bolts 56, 58 placed through the square hole from the face of the U-plate (square holes) and two barrel nuts are set through the round holes of the back plate and engaged with the carriage bolts.

Assembly method #2—where the connecting bolts showing on the exterior of furniture legs are non-decorative. The assembly steps a comprise:

Step 1. the furniture legs 12 are pre-drilled all the way through the leg to the diameter of a barrel nut;

Step 2. carriage bolts 56, 58 are placed through the square holes of the U-plate butt 26 from the inside;

Step 3. the U-plate with its carriage bolts in place are then fitted in and through the holes of the leg, and fully secured with two barrel nuts from the exterior of the leg;

Step 4. follow step #4 in the assembly method #1 above.

Assembly method #3—where the connecting bolts showing on the exterior of legs are decorative or sculpted. The assembly steps comprise:

Step 1. the furniture legs 12 are pre-drilled all the way through the leg to the diameter of a barrel nut;

Step 2. two decorative or sculpted bolts are place through the pre-drilled holes from the exterior side of the leg;

Step 3. U-plate 26 is secured to the furniture leg by placing its butt side holes (round) over and onto the threaded end of sculpted bolts projecting from the furniture legs, and fully securing it with two barrel nuts.

Step 4, follow step #3 in the assembly method #2 above.

FIGS. 3 and 4 illustrate an embodiment comprising bed furniture having a headboard unit 61 which includes a pair of legs 63, 65 which are joined together with horizontal boards 67, 69 by a plurality of furniture assemblies 71, 77 which can be comprised of the U-plates described in connection with the embodiment of FIGS. 1-10. In this embodiment the U-plates 73, because they are typically covered when the bed is in use, can eliminate the decorative opening that is provided for the upper furniture assembly 71. The footboard unit is comprised of a horizontal board 75 which is mounted at its opposite ends to leg 63 by a pair of U-plates 77, which are also formed similar to the U- plates described for the embodiment of FIGS. 1-10.

FIGS. 11-14 illustrate details of the U-plate 27 which, when joined with a U- plate of similar configuration, forms a structural joint in accordance with another embodiment. U-joint 27 is comprised of a pair of spaced-apart faces 45, 47 through which square-shaped openings 31, 35 and 37, 49, respectively, are formed. A butt 41 joins the two faces together, and a pair of square-shaped openings 33, 39 are formed in the butt. The faces are formed similar to the U-plate of FIGS. 5-10, except that the decorative openings are omitted and the ends of the faces are blunt. The pair of U-plates 27 are assembled with furniture pieces in a manner similar to that described for the embodiment of FIGS. 5-10.

FIGS. 15-17 show another embodiment providing a furniture assembly comprising an L-plate 60. The purpose of the L-plate is to produce an assembly that is quite strong but of lighter weight than the U-plate.

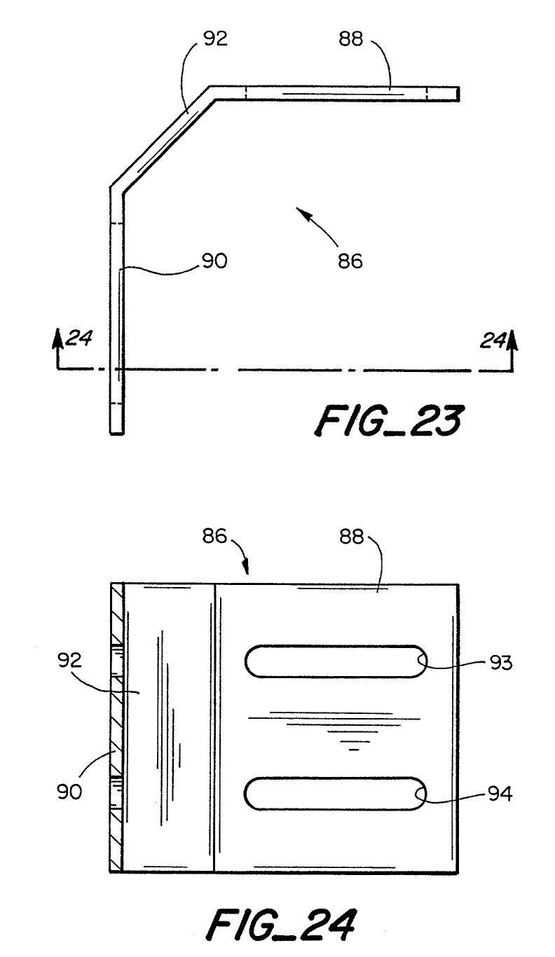

L-plate 60 comprises a single plate design in the form of a letter “L.” The L-plate design has two sides, a face 62 and butt 64. The face is the side that receives design elements, such as a decorative opening, and the butt is the side that connects to the leg 66 of a furniture piece. Since there is no backing plate called for in this design, there are two options for meeting special structural needs. One is using washers between the head of the bolt or nut and the wood rail 68, and second by using the universal back-plate of FIGS. 23-25.

The assembly steps for connecting L-plate 60 to the furniture legs comprise:

Step 1. the L-plate is fully secured to leg 66 using one of the three bolting methods (blind, exposed barrel nut or sculpted bolt head);

Step 2. a wooden rail 68 is fully secured to the backside of the faceplate, using one of the two fastening methods (blind or exposed);

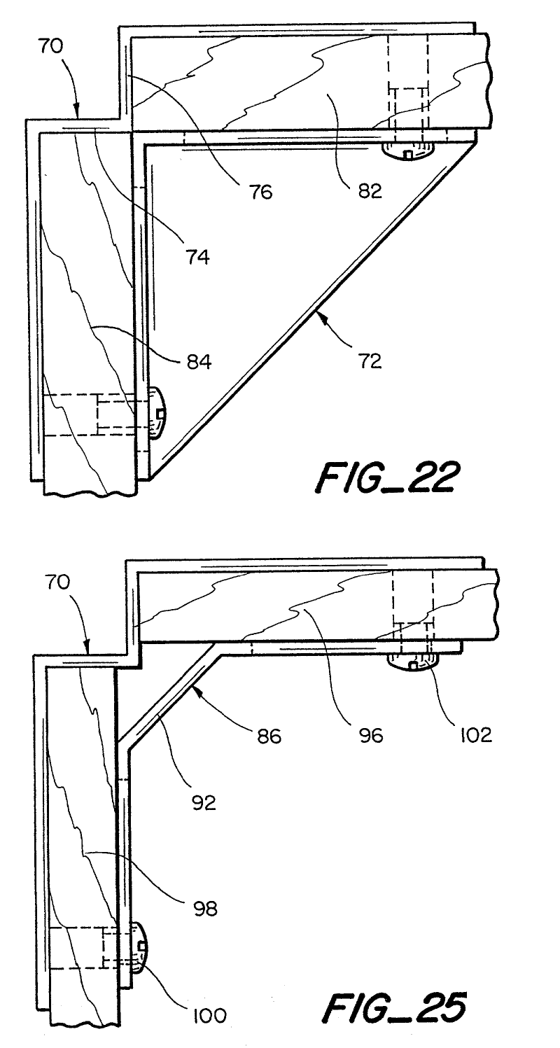

FIGS. 18-19 illustrate a V-plate 72 for use as a component in the assembly shown in FIG. 22. The V-plate has a secondary purpose in providing support to a shelf in a cabinet or chest.

FIGS. 20 and 21 illustrate an M-plate 70 which is used in combination with V-plate 72 to form the assembly of FIG. 22. The purpose of the M-plate 70 is to offer another level of increased strength by binding two furniture rails with a single assembly plate rather than two.

M-plate 70 is comprised of a four sided outer plate having an M shape. The corner of the plate is formed with inwardly extending short plates 74, 76 which form a V-shaped or “stepped” face plate which are sized to fit with the adjoining sides of a vertical leg. V-plate 72 comprises a three sided backplate as shown in FIG. 18, or it could also be a two side L shaped plate, depending on the thickness of the wood rails 82, 84 (FIG. 22) being used. Outer plate 78 or 80 is the plate that receives any design applications such as a decorative opening. Fastening the wood furniture rails to the M-plate uses the same processes used in all other furniture assembly plate designs, that is, either visible or invisible fasteners as viewed from the exterior or face of the furniture assembly plate.

The M-plate does not necessarily require an interior backplate, it depends primarily on the type and size of furniture and the thickness, density and overall strength of the wood used in the furniture rails. If no interior plate is used, washers are used in its place like the L-plate assembly.

Also the size of the M-plate, and the dimension of the “step” is determined by the furniture piece and size, as well as the thickness of the of the rails and legs of the furniture piece.

The assembly method of the M-plate comprises:

Step 1. faceplate 74, 76 is attached to a furniture leg using the assembly methods #1 or #2 as described for the U-plate design above;

Step 2. both wooden rails are then put in place from the backside of the faceplate;

Step 3. V-plate corner backplate 86, if desired, is then put in place and male button head screws are inserted and fully tightened. Depending on desired strength of the joint, no V-plate or corner backplate may be required, and washers may be substituted.

FIGS. 23-25 illustrate a furniture assembly comprising the corner backplate 86. The purpose of the corner back-plate is for the construction of case goods (cabinets and chests). With case goods, flat horizontal surfaces (shelves or the bottom of a chest) need to be secured to the furniture piece. The corner backplate is formed with a pair of faceplates 88, 90 which are oriented orthogonal and are joined at their inner edges with a center section 92. Faceplates are each formed with a pair of horizontally extending, parallel elongate openings 93, 94 of a size suitable for receiving fasteners. FIG. 25 illustrates the corner backplate 86 in assembled relationship with an M-plate as in FIG. 20 showing a pair of furniture rails 96, 98 secured between the two plates. In this configuration, the angled relationship of center portion 92 allows clearance for the “step” of M-plate 70. Fasteners 100, 102 are fitted through openings 93 of the corner backplate.

FIG. 22 illustrates another embodiment providing a furniture assembly comprising the M-plate 70 of FIG. 20 and a back-plate 72 of FIG. 18.

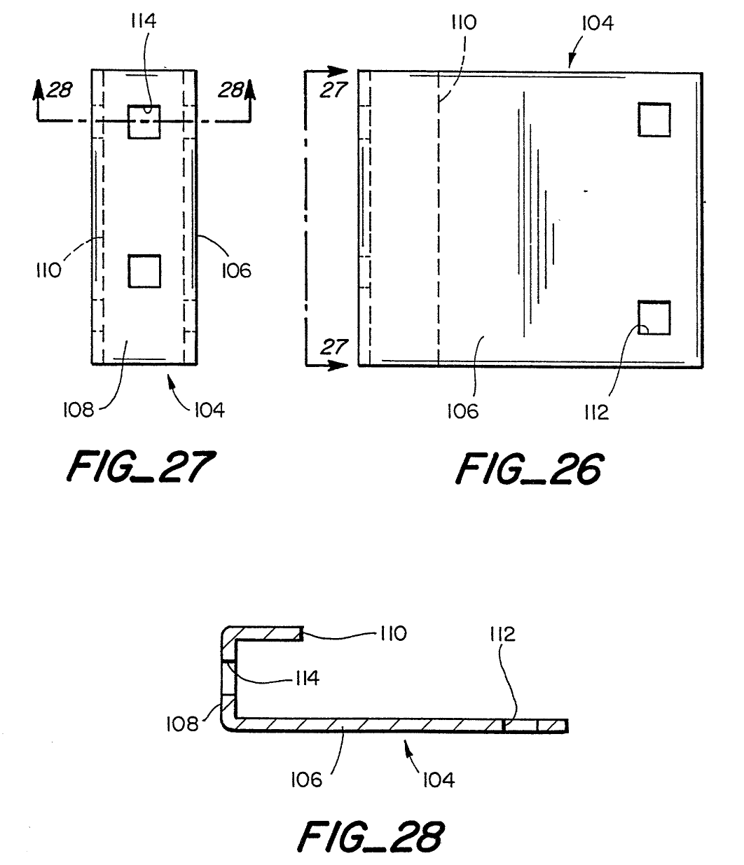

FIGS. 26-28 illustrate a furniture assembly comprising a J-plate 104. The purpose of the J-plate is to produce a slightly stronger assembly than the L-plate, but less weight of the U-plate.

J-plate 104 is a single plate design in the form of a letter “J.” The J-plate is comprised of a face 106, butt 108 and an abbreviated backplate 110. Face 106 is formed with a pair of openings 112 for receiving fasteners, and butt 108 is formed with an opening 114, also for receiving a fastener. The face is the side that receives design elements and the butt is the side that connects to the leg of a furniture piece. The abbreviated backplate provides some additional support for situations requiring additional structural support. Since there is no backing plate called for in this design, there are two options for meeting special structural needs. One is using washers between the head of the bolt or nut and the wood rail, and second using a corner Back-Plate.

The steps in assembling the J-plate comprise.

Step 1. the J-plate is fully secured to the leg using one of the three bolting methods (blind, exposed barrel nut or sculpted bolt head);

Step 2. a wooden rail is fully secured to the backside of the faceplate by slipping it under the abbreviated backplate and then securing it using one of the two fastening methods (blind or exposed) to washers or a corner backplate, depending on joint strength requirements.

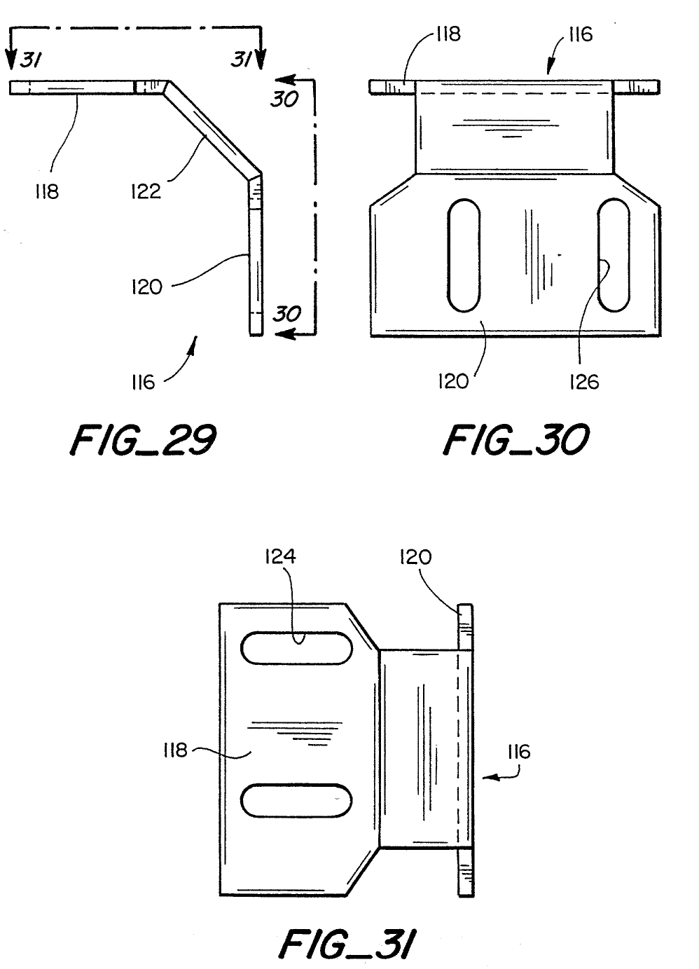

FIGS. 29-31 illustrate a furniture assembly comprising a universal backplate 116. The purpose of the universal backplate is to serve as an all purpose backplate, and to provide additional support and strength for the J- and L-plates that have no backplate. Universal backplate 116 is comprised of a pair of orthogonally oriented face plates 118, 120 which are joined at their inner sides by an angled center plate 122. Plate 118 is formed with a pair of parallel elongate openings 124 for receiving fasteners, while plate 120 is formed with a pair of elongate openings 126, also for receiving fasteners.

Most furniture assemblies of the invention can be connected to furniture legs by butting them directly up to the leg or by having a recessed connection (mortise cut into the leg), where the furniture assembly is actually inserted into the leg making for a more crafted look and connection. Most all furniture assembly plate designs support the mortise inset design except for the M-plate. Another recessed method is the rabbet. Here instead of having a hole cut into the furniture leg, a hole with two sides is cut from the corner of a furniture leg. The side that butts to the furniture assembly plate is longer and the side that butts to the backplate is shorter. The rabbet also provides a more crafted look and connection.

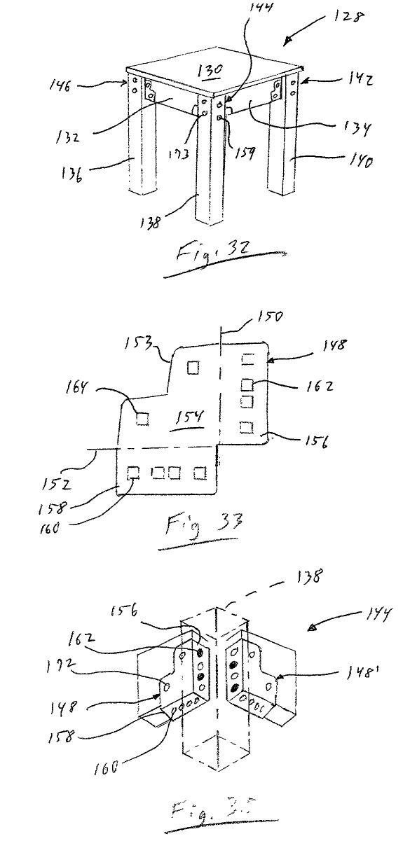

FIGS. 32 to 35 illustrate an embodiment providing a furniture assembly 128, shown as an end table. The assembly comprises a flat table top 130, four horizontal rails 132-134 supporting the table top, four upright legs 136-140, and four structural corner joints 142-146 which connect to the rails and legs. Each corner joint comprises two identical plates 148 that are shaped as described in connection with FIGS. 33 to 35. The table top, rails and legs can be of wood.

Plate 148 is typical of the corner joint plates and is shown in FIG. 33 in a flat shape prior to being folded along the fold lines 150, 152. The plate can be shaped from a sheet of metal by suitable means such as die cutting or stamping, or by laser or high-pressure water jet cutting machines. Plate edge 153 can be shaped with any desired decorative motif, such as the stepped design shown in FIG. 33.

After cutting, adjacent sides of the plate are folded through 90° toward the same side to form a configuration having a face 154 and two butts 156, 158 that are orthogonal to one another. Before or after the cutting step, the plate is formed with fastener holes comprising a plurality, preferably four, of aligned holes 160 in butt 158, four aligned holes 162 in butt 156, and two holes 164 in the face. The holes are square shaped for seating the square shoulders of carriage bolts. Each of the holes 160 are oriented offset from the respective holes 162 to avoid interference between the carriage bolts when they are assembled.

As best shown in FIG. 35, a corner of the furniture has a pair of identical first and second corner joint plates 148, 148′ for connecting each leg to the rails. The first plate 148 is mounted in its illustrated orientation on the left outer side of leg 138 (shown in phantom view). In this orientation butt 158 is in supporting relationship horizontally flat below the end of first rail 132, while butt 156 vertically fits between the rail stub end and left inside of the leg.

Corner joint plate 148 is mounted to leg 138 by means of a pair of carriage bolts 159 (only the bolt heads are shown in FIG. 32) which extend parallel within vertically spaced corresponding through-holes that are drilled in the top of the leg. The ends of these bolts fit into a pair of the holes 162 that are at the top and third-from-top in butt 156. The distal ends of these bolts that project out the back of the holes 162 are fastened by barrel nuts (not shown).

Plate 148 is also mounted to rail 132 by means of a pair of carriage bolts 172 (only the bolt heads are shown in FIG. 35) which fit into a pair of the holes 164 in face 153 and extend parallel within spaced through-holes that are drilled in the rail. The distal ends of these bolts that project out the back of the through-holes are fastened by barrel nuts (not shown). In the assembled orientation of plate 148 the remaining two holes of butt 156 and all four holes 160 of butt 158 are not used.

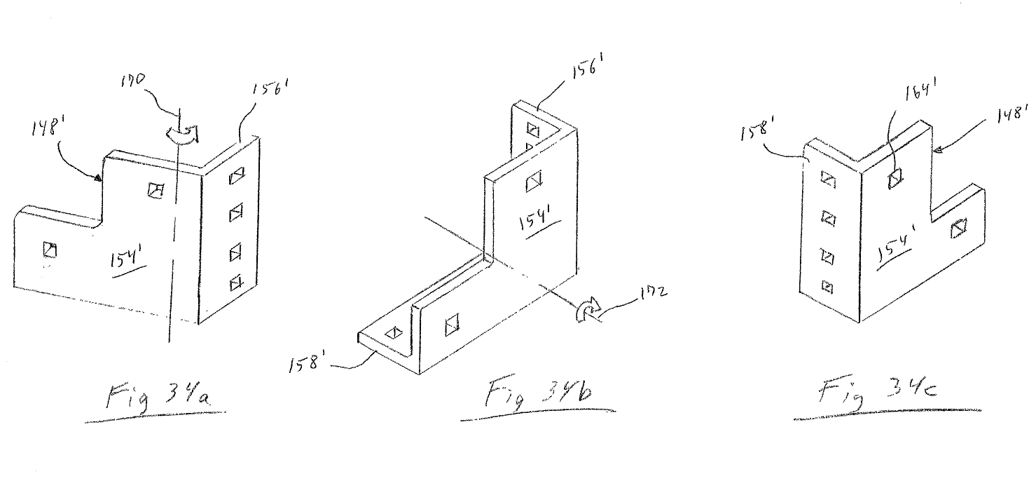

All of the corner joint plates used in this embodiment are identically shaped for universal application so that they can be used on either side of any of the table legs. Thus, a second corner joint plate 148′ is provided for attachment to the right outer side of leg 138 and to the second rail 134. The invention contemplates that a homeowner or other non-professional person could easily assemble the furniture from a kit using simple tools. FIGS. 34a, 34b and 34c illustrate the way in which the person would be directed, such as from an instruction sheet in the kit, to orient the plates in proper position for assembly. Starting with the orientation for the left mounting position of FIG. 34a, the person rotates the plate 90° about the vertical axis 170 anti-clockwise as viewed from above to the intermediate position of FIG. 34b. From that position the plate is rotated 90° about the horizontal axis 172 clockwise as viewed from the right to the position of FIG. 34c.

With plate 148′ in the position shown in FIG. 34c, its butt 156′ is in supporting relationship horizontally flat below the end of second rail 134, while butt 158′ vertically fits between the stub end of the rail and the right inside of the leg. Carriage bolts are then inserted into the two holes 164′ of face 154′ and through-holes drilled in the rail where they are fastened by barrel nuts in the manner explained above for plate 148. So as to avoid interference with the fastening bolts fitted through butt 156 of the first joint plate, carriage bolts are inserted into the bottom and third-from-bottom holes in butt 158′ and corresponding through-holes drilled in the leg. These bolts are also fastened by barrel nuts in the manner explained above.

In the assembled orientation of corner joint plate 148′, the remaining two holes of butt 158′ and all four holes of butt 156′ are not used.

There are many advantages from the universal corner joint plate provided by this embodiment. When the plate is die cut, only one die need be designed and used for all plates, and the butts for all plates are folded in the same directions. This reduces manufacturing costs. Their are fewer parts to keep in the manufacturer's inventory, thus reducing costs to the manufacturer and price to the end-user from savings on shipping, handling, tracking and warehousing of the joint plates. Also, with only a single part number needed for all joints, ordering of parts is simplified. And assembly by the customer is easier and faster.

Interfacing Furniture Assembly Plates to Furniture Legs

Most furniture assemblies can be connected to furniture legs by butting them directly up to the leg or have a recessed connection (mortise cut into the leg), where the furniture assembly is actually inserted into the leg making for a more crafted look and connection. Most all furniture assembly plate designs support the mortise inset design except for the M-plate. Another recessed method is the rabbet. Here instead of having a hole cut into the furniture leg, a hole with two sides is cut from the corner of a furniture leg. The side that butts to the furniture assembly plate is longer and the side that butts to the backplate is shorter. The rabbet also provides a more crafted look and connection.

While the foregoing embodiments are at present considered to be preferred it is understood that numerous variations and modifications may be made therein by those skilled in the art and it is intended to cover in the appended claims all such variations and modifications as fall within the true spirit and scope of the invention.

What is claimed is:

1. An assembly for joining first, second and third pieces of furniture together to form a structural joint, the assembly comprising the combination of first and second plates, each plate having a face and a butt, each face being formed with a first opening centered along a first axis which is orthogonal with the first piece for receiving a first fastener to secure the first piece to the first plate, the butt being formed with a second opening, said second opening of the butt of the first plate extending into the third piece along a second axis for receiving a second fastener, said second opening of the butt of the second plate extending into the third piece along a third axis for receiving a third fastener, and said second and third axes being positioned in spaced-apart relationship to enable the second and third fasteners to extend into the third piece without interference.

2. An assembly as in claim 1 in which the first and second plates each further comprising a back, each butt holding the respective back and face in spaced-apart relationship to form respective first and second slots in each plate, the slots of the first and second plates being adapted for seating the respective first and second pieces.

3. An assembly as in claim 1 in which the butts of the first and second plates are joined together along a common edge to form an L-shaped cavity for receiving the third piece.

4. An assembly as in claim 3 and further comprising an L-shaped backup plate having walls which are joined together along a common joint which is aligned with the common edge.

5. An assembly as in claim 4 in which the common joint comprises an edge.

6. An assembly as in claim 4 in which the common joint comprises a flat plate.

7. An assembly as in claim 1 in which at least one of the fasteners comprises a bolt.

8. An assembly as in claim 1 in which at least one of the fasteners comprises a stud.

9. An assembly as in claim 1 in which at least one of the fasteners comprises an internally threaded sleeve together with a hanger bolt that is adapted for fastening into the sleeve.

10. An assembly as in claim 1 in which the third piece comprises an upright leg of the furniture.

11. An assembly as in claim 10 in which at least the second piece comprises a horizontal rail of the furniture.

12. An assembly as in claim 1 in which the first and second plates each have a second butt, each second butt having a third opening for receiving a fastener which connects with the third piece.

13. An assembly as in claim 12 in which the first and second butts project orthogonally from one side of the face with the first plate being in a first orientation for connecting together the first and third pieces and with the second plate being in a second orientation for connecting together the second and third pieces

14. An assembly as in claim 13 and further comprising a fourth fastener mounted in the third opening and extending into the third piece.

15. An assembly as in claim 14 in which the third piece has first and second sides, and the first and second plates have identically sized and shaped faces for enabling the plates to be assembled with the fourth fastener extending into either of the first or second sides of the third piece.
